(19) United States
(12) Patent Application Publication
(10) Pub. No.: US 2015/0308471 A1
(43) Pub. Date: Oct. 29, 2015

(54) LOCKING TENSIONER FOR A ROLLER BLIND

(71) Applicant: ZMC Metal Coating Inc., Woodbridge (CA)

(72) Inventor: Philip Ng, Thornhill (CA)

(21) Appl. No.: 14/543,543

(22) Filed: Nov. 17, 2014

(30) Foreign Application Priority Data
Apr. 29, 2014 (CA) 2850673

(51) Int. Cl. F16B 2/10; E06B 9/78

(52) U.S. Cl. CPC F16B 2/10; E06B 9/78

(57) ABSTRACT

A locking tensioner for a roller blind. The roller blind is of the type having a roller and a looped chain or cord to impart rotational movement to the roller. The locking tensioner comprises first and second members, each having a first end and a second end. The first ends have apertures dimensioned to receive therethrough the chain or cord of the roller blind. The first and second members are rotatably secured to one another and rotatable about an axis between a locked and an unlocked configuration. When the first and second members are in their unlocked configuration the apertures are aligned permitting the chain or cord to freely move through both of the apertures. When the members are in their locked configuration the apertures are at least partially misaligned restricting the movement of the chain or cord through the apertures. The locking tensioner includes a spring biasing the first and second members toward their locked configuration.

### FIELD

This invention relates generally to roller blinds, or roller shades, and in particular to a new and novel locking tensioner for a cord or chain of a roller blind or roller shade.

### BACKGROUND

One common form of window shade or window covering comprises a fabric or other material that is wound upon a roller that is fixed or mounted to the top portion of the window frame. The fabric can be pulled downwardly and unrolled from the roller in order to block or minimize the amount of light infusion through the window. When it is desired to allow unrestricted light to pass through the window the fabric is typically wound back onto the roller through the use of one of a wide variety of different mechanical mechanisms. Most commonly, a looped rope, cord to chain is operatively connected to the roller through the use of a clutch. Pulling on one of the legs of the rope, cord or chain will typically cause the clutch to impart rotational movement to the roller in a first direction, which will either unwind the fabric from the roller or rewind the fabric back onto the roller. Similarly, pulling downwardly on the other leg of the rope, cord or chain will cause the roller to rotate in the opposite direction. Since the roller and the clutch mechanism will be mounted at the top of the blind, and at the top of window frame, in many cases a relatively long cord or chain is required, particularly for windows or openings of a substantial vertical height. Unfortunately, long looped ropes, cords or chains have been found to present strangulation hazards for small children, and sometimes pets.

As a result of the potential for children and/or pets to become entangled about long loops of chain or cord hanging from a roller blind, a number of jurisdictions have legislated regulations stipulating that, when properly installed, the roller blind must not operate unless a cord tensioner is in place. Such cord tensioners must be fastened to a wall or window frame in order to hold the cord or chain tightly against the side of the wall or window frame and to eliminate or substantially reduce the likelihood of a child becoming entangled in the cord or chain. From a blind operational perspective the tensioner must hold the two legs of the looped cord relatively parallel in order to ensure a smooth operation of the clutch mechanism. In some jurisdictions, regulations further stipulate that the tensioner must effectively render the roller blind inoperable should the tensioner not be secured to a wall or frame, or should it at some point become detached from the wall or window frame.

Accordingly, the present invention concerns a mechanism that assists in maintaining a rope, cord or chain of a roller in tension and secured to a wall or window frame when the blind is operational. The invention also assists in rendering the roller blind inoperable, or partially inoperable, should the mechanism become detached or partially detached from the wall or window frame.

### SUMMARY

There is therefore provided a locking tensioner for a roller blind, the roller blind of the type having a roller and a looped chain or cord to impart rotational movement to the roller, the locking tensioner comprising first and second members, each of said first and second members having a first end and a second end, said first ends having apertures dimensioned to receive therethrough the chain or cord of the roller blind, said first and second members rotatably secured to one another and rotatable about an axis between a locked and an unlocked configuration, when in said unlocked configuration said apertures aligned permitting the chain or cord to freely move through both of said apertures, when in said locked configuration said apertures at least partially misaligned restricting the movement of the chain or cord through said apertures, said locking tensioner including a spring biasing said first and second members toward said locked configuration.

There is also provided a locking tensioner for a roller blind, the roller blind of the type having a roller and a looped chain or cord to impart rotational movement to the roller, the locking tensioner comprising first and second members, each of said first and second members having a first end and a second end, said first ends having apertures dimensioned to receive therethrough the chain or cord of the roller blind, said first and second members rotatably secured to one another and rotatable about an axis between a locked and an unlocked configuration, when in said unlocked configuration said apertures aligned permitting the chain or cord to freely move through both of said apertures, when in said locked configuration said apertures at least partially misaligned restricting the movement of the chain or cord through said apertures, each of said second ends containing an opening for the passage of a fastener, said second ends aligned and overlying one another when said locking tensioner is in said unlocked configuration to permit a fastener to be received through both of said second ends to secure said tensioner to a window frame, said locking tensioner including a spring biasing said first and second members toward said locked configuration.

Further aspects of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a front view of a window frame having mounted thereon a roller blind utilizing a locking tensioner in accordance with the present invention.

FIG. 2 is an upper side perspective view of FIG. 1.

FIG. 3 is a view similar to FIG. 1 wherein the tensioner is partially detached from the window frame, thereby locking the rope, cord or chain of the window blind.

FIG. 4 is an upper side perspective view of FIG. 3.

FIG. 5 is a side elevational view of a locking tensioner constructed in accordance with a preferred embodiment of the present invention.

FIG. 6 is an exploded view of the locking tensioner in FIG. 5.

FIG. 7 is a side elevational view of the locking tensioner of FIG. 3.

FIG. 8 is a lower perspective view of the locking tensioner of FIG. 7.

FIG. 9 is a front view of a window frame having mounted thereon an alternate embodiment of the locking tensioner of the present invention.

FIG. 10 is an upper side perspective view of FIG. 9.

FIG. 11 is an upper side perspective view of a window frame having the locking tensioner of FIG. 9 mounted upon its exterior face.

FIG. 12 is a view similar to FIG. 9 wherein the locking tensioner is partially detached from the window frame.

FIG. 13 is an upper side perspective view of FIG. 12.

FIG. 14 is a side elevational view of the locking tensioner shown in FIG. 9.

FIG. 15 is an upper perspective view of locking tensioner shown in FIG. 14.

FIG. 16 is an exploded view of the locking tensioner shown in FIG. 14.

FIG. 17 is a side elevational view of the locking tensioner of FIG. 12.

### DESCRIPTION

The present invention may be embodied in a number of different forms. The specification and drawings that follow describe and disclose some of the specific forms of the invention.

Referring to the attached drawings, there is shown a generic roller blind 1 of the type having a roller 2 and a looped chain or cord 3 to impart rotational movement to the roller. Typically, the chain or cord will be in a continuous loop and received about a clutch or drive mechanism 4 that imparts rotational movement to the roller in either a clockwise or counter-clockwise direction, depending on which leg of the chain or cord is pulled in a downward fashion. In that matter, blind fabric 5 can either be lowered in front of window 6 or retracted back on to roller 2.

For purposes of safety, and in many cases to comply with local jurisdictional regulations, the roller blind will include a locking tensioner 7. One of the primary purposes of tensioner 7 is to hold the chain or cord 3 taughtly and securely to the frame of window 6, or in some cases to an adjacent wall or other fixed or rigid structure.

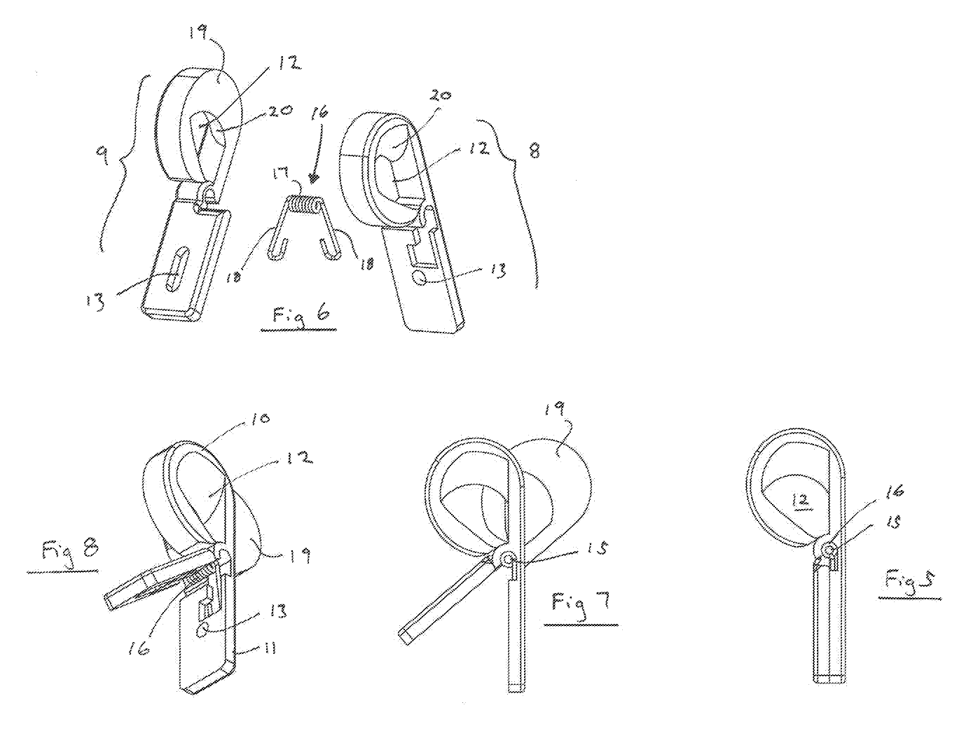

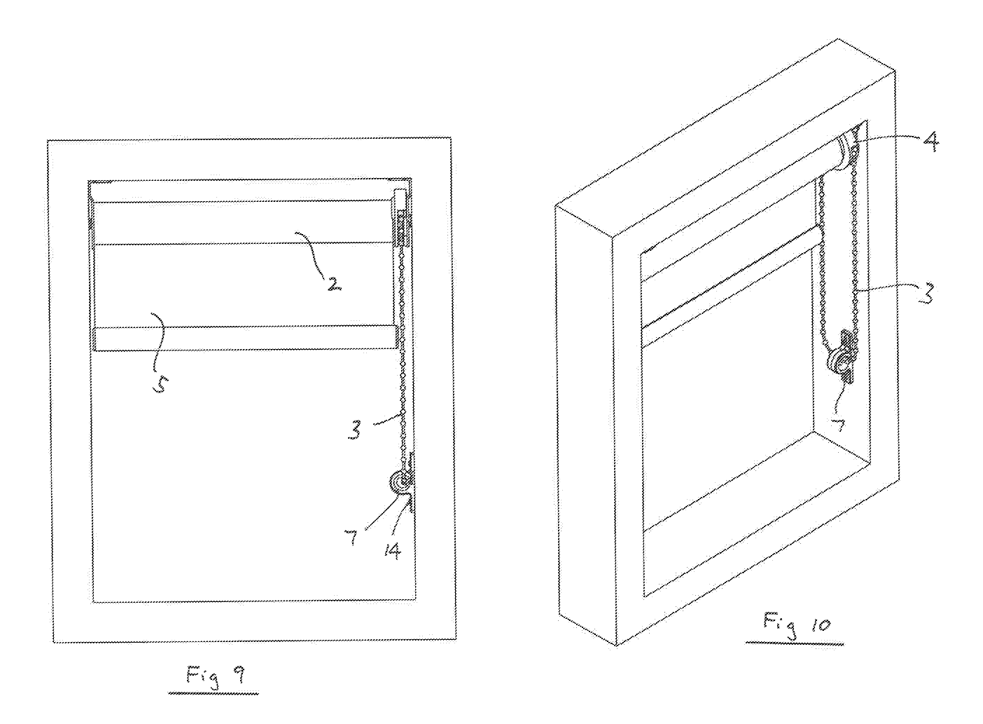

With specific reference to FIGS. 5 through 8, locking tensioner 7 is comprised of first and second members 8 and 9 that, in turn, each have first ends 10 and second ends 11. First ends 10 of members 8 and 9 each include apertures 12 that are dimensioned to receive therethrough cord or chain 3. In one aspect of the invention at least one of second ends 11 of members 8 and 9 includes an opening 13 for the passage of a fastener 14 used to secure the locking tensioner to the frame of window 6.

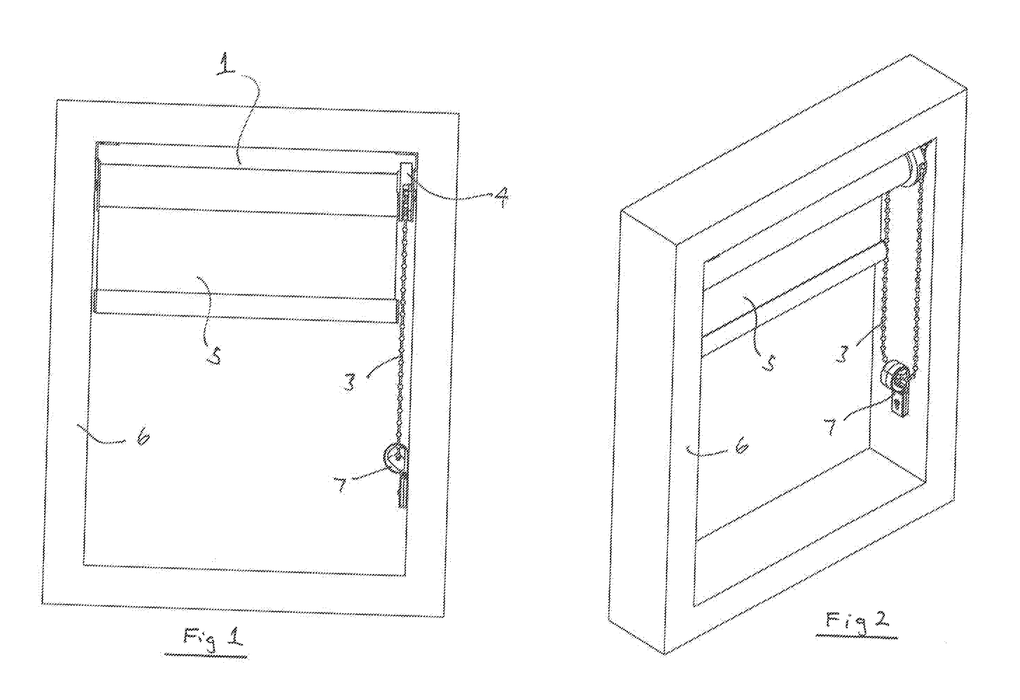

First and second members 8 and 9 are rotatably secured to one another and rotatable about an axis 15 between a locked (see FIG. 7) and an unlocked (see FIG. 5) configuration. When first and second members 8 and 9 are in an unlocked configuration (see FIGS. 1, 2 and 5) apertures 12 will be generally aligned, thereby permitting chain or cord 3 to freely move through both of the apertures and to permit normal operation of the roller blind. However, when members 8 and 9 are in their locked configuration apertures 12 are at least partially misaligned thereby restricting the movement of the chain or cord through the apertures in order to at least partially prevent or hinder the normal operation of roller blind 1. The locking tensioner includes a spring 16 that biases the first and second members toward their locked configuration.

In the embodiment of the invention shown in FIGS. 1 through 8, each of second ends 11 of first and second members 8 and 9 contains an opening 13 for the passage of a fastener therethrough. In addition, it will be appreciated that in the embodiment shown in FIGS. 1-8 second ends 11 align and overlie one another when locking tensioner 7 is an its unlocked configuration to permit a single fastener 14 to be received through both openings 13 in second ends 11. In this manner a single fastener (for example a screw) can be utilized in order to rigidly secure locking tensioner 7 to the frame of window 6.

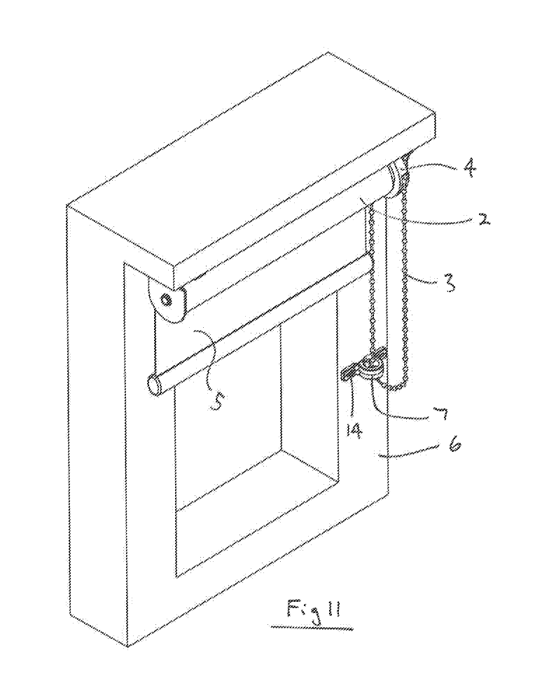

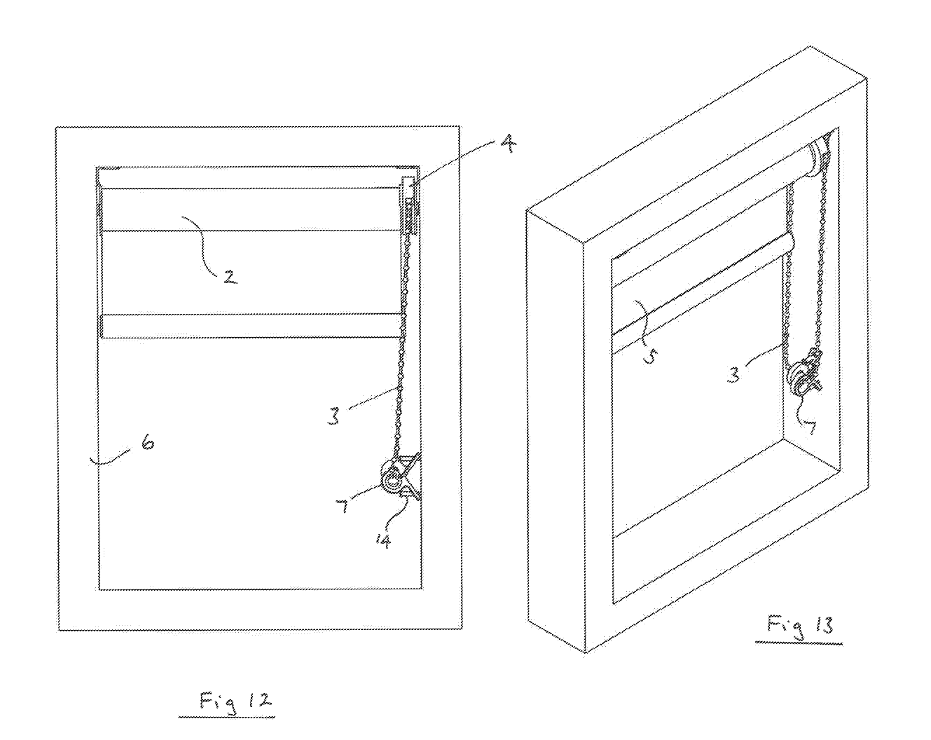

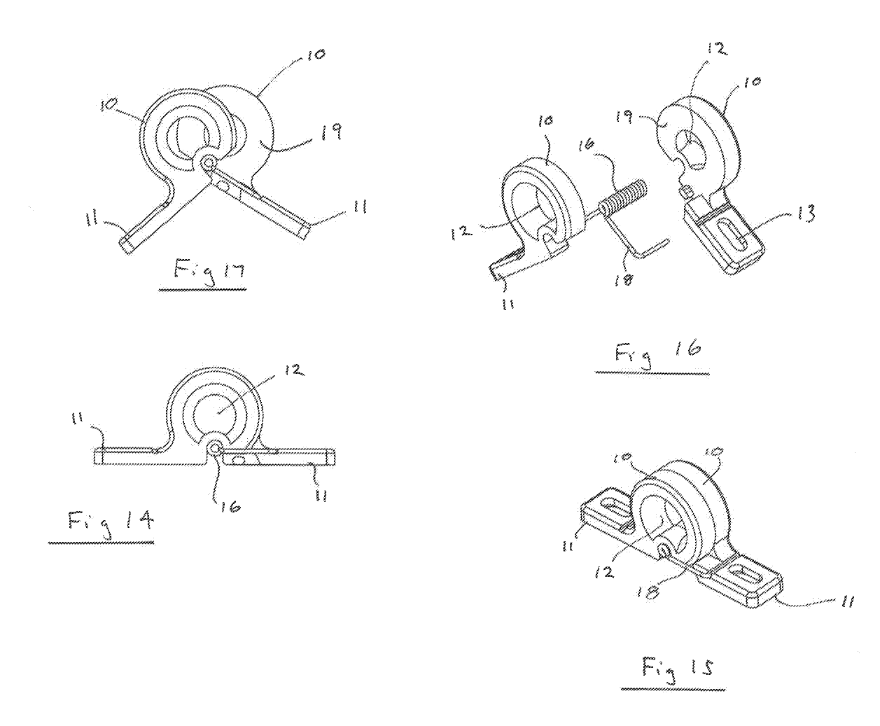

FIGS. 9 through 17 show an alternate embodiment of the invention wherein second ends 11 of the first and second members 8 and 9 are opposed in direction relative to one another. In this embodiment, each of second ends 11 (which face in opposite directions) includes an opening 13 for the receipt of a separate fastener that is used to rigidly secure each of ends 11 to a window frame, etc.

In a preferred embodiment of the invention spring 16 is a torsion spring that includes a helical portion 17 and a pair of arms 18. Each of arms 18 bears against a different one of first and second members 8 and 9. Helical portion 17 comprises axis 15 about which the first and second members rotate when moving between their locked and unlocked configurations. First ends 10 have smooth inner faces 19 that are in “scissor-like” or “by-pass” contact with each other and slidable past one another when the locking tensioner moves between its locked and unlocked configurations. When the locking tensioner is in its locked configuration torsion spring 16 will bias first ends of 10 in opposite rotational directions, thereby applying a shear load upon a chain or cord that is received through apertures 12. The shear loading of the chain or cord restricts its movement through the apertures and limits or prevents rotation of roller 2.

The functionality and operation of locking tensioner 7 will now be described in further detail with specific reference to the drawings. In the case of the embodiment shown in FIGS. 1 through 8, locking tensioner 7 is secured to a window frame through passing a single fastener through aligned openings 13 on the second ends of members 8 and 9. When secured to a window first ends 10 of the first and second members will be aligned with their smooth inner faces in contact, and with chain or cord 3 passing through their aligned apertures. As shown in the attached drawings, first ends 10 may include a smooth bearing portion 20 upon which the chain or cord can ride as it is operated in order to allow for smooth movement of the chain or cord, and to also minimize noise. FIGS. 1 and 2 show the locking tensioner and the chain or cord in an unlocked configuration with the cord being held relatively taughtly and adjacent to the window frame. At this point torsion spring 16 will be compressed. The receipt of fastener 14 through second ends 11 of first and second members 8 and 9 and into the window frame effectively prevents rotational movement of the first and second members about the helical portion of the spring and retains tensioner 7 in its locked configuration.

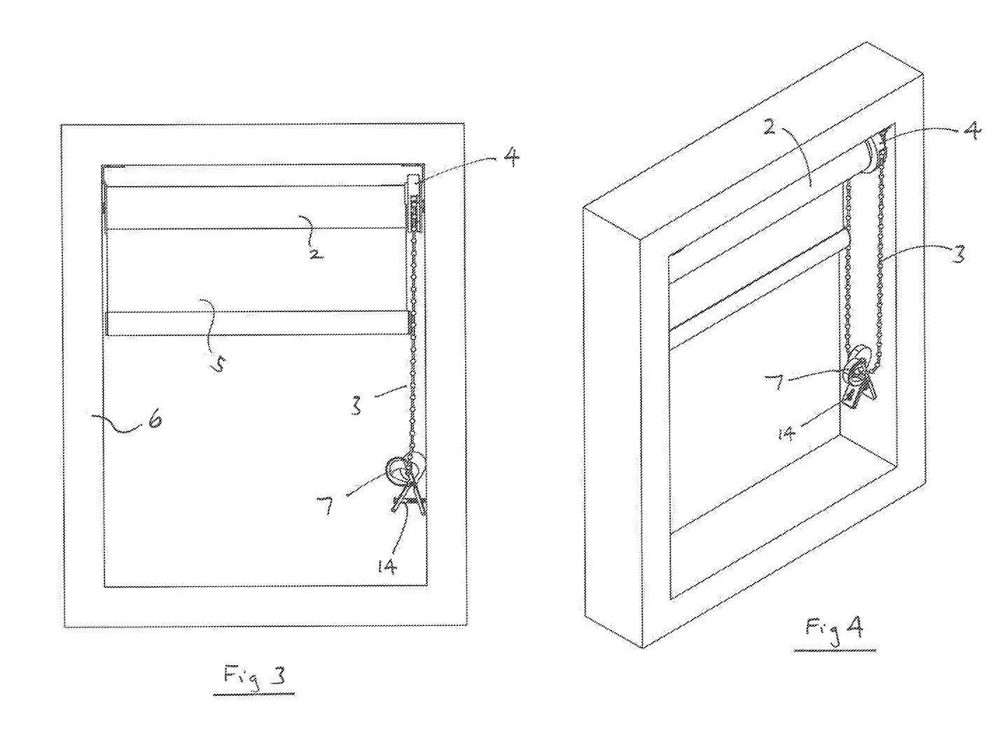

Should for any reason the fastener become detached or partially detached from the window frame the force counter acting the action of torsion spring 16 will be either minimized or removed, causing the arms of the spring to rotate the first and second members about the spring's helical portion. Locking tensioner 7 will thus be rotated from its unlocked to its locked configuration with the inner faces 19 of the first and second members moving in “scissor-like” or “by-pass” contact until each of the faces comes into contact with the chain or cord, applying a shear load to the chain or cord. The strength of torsion spring 16 and the first and second members is such that the chain or cord will not be sheared off, but rather the chain or cord will be held or gripped by the first and second members. Such a configuration is shown in FIGS. 3 and 4. Through the shear loading of the chain or cord the ability to pull either leg of the chain or cord downwardly to impart rotational movement to roller 2 will be either prevented or limited. Where fastener 14 is still at least partially secured to the window frame, locking tensioner 7 will remain somewhat fixed in place, preventing the chain or cord from being rotated. Should the fastener become fully detached from the window frame the chain or cord could be pulled in one direction or the other, however, only until such time as the tensioner comes into contact with the clutch. A that point the roller blind will effectively become non-operational. In either case, it will be appreciated that a loosening of fastener 14, or its complete removal from the window frame, will cause the locking tensioner to move from its unlocked to its locked configuration, thereby rendering the roller blind inoperable until such time as the fastener is re-secured to the window frame.

The embodiment shown in FIGS. 12 through 17 is essentially parallel in terms of its operation and function to that shown in FIGS. 1 through 8. However, as indicated above, rather than second ends 12 being overlaid with a single fastener passing therethrough, the second ends are opposed in direction to one another with a separate fastener securing each end to the window frame. It will be appreciated that in this embodiment the removal or partial removal of either one of the fasteners (or both) will result in the torsion spring causing the first and second members to rotate relative to one another and the locking tensioner to move from its unlocked to its locked configuration. When in its locked configuration the first and second members will apply a shear force or load to the chain or cord in the same general manner as the embodiment shown in FIGS. 1 through 8.

It is to be understood that what has been described are the preferred embodiments of the invention. The scope of the claims should not be limited by the preferred embodiments set forth above, but should be given the broadest interpretation consistent with the description as a whole.

I claim:

1. A locking tensioner for a roller blind, the roller blind of the type having a roller and a looped chain or cord to impart rotational movement to the roller, the locking tensioner comprising:
first and second members, each of said first and second members having a first end and a second end, said first ends having apertures dimensioned to receive therethrough the chain or cord of the roller blind,
said first and second members rotatably secured to one another and rotatable about an axis between a locked and an unlocked configuration, when in said unlocked configuration said apertures aligned permitting the chain or cord to freely move through both of said apertures, when in said locked configuration said apertures at least partially misaligned restricting the movement of the chain or cord through said apertures,
said locking tensioner including a spring biasing said first and second members toward said locked configuration.

2. The locking tensioner as claimed in claim 1 wherein each of said second ends contains an opening for the passage of a fastener, said second ends aligned and overlying one another when said locking tensioner in said unlocked configuration to permit a fastener to be received through both of said second ends, securing said tensioner to a window frame.

3. The locking tensioner as claimed in claim 1 wherein said spring is torsion spring.

4. The locking tensioner as claimed in claim 3 wherein said torsion spring includes a helical portion, said helical portion comprising said axis about which said first and second members rotate when moving between said locked and unlocked configurations.

5. The locking tensioner as claimed in claim 4 wherein said first ends have smooth inner faces, said inner faces in scissor-like contact with each other and slidable past one another when said locking tensioner moves between said unlocked and said locked configurations, when in said locked configuration said torsion spring biasing said first ends in opposite rotational directions thereby applying a shear load upon a chain or cord passing through said apertures to restrict movement of the chain or cord through said apertures.

6. The locking tensioner as claimed in claim 1 wherein at least one of said second ends includes an opening for the passage of a fastener to secure said locking tensioner to a window frame.

7. The locking tensioner as claimed in claim 5 wherein each of said second ends contains an opening for the passage of a fastener, said second ends aligned and overlying one another when said locking tensioner in said unlocked configuration to permit a fastener to be received through both of said second ends, securing said tensioner to a window frame.

8. The locking tensioner as claimed in claim 1 wherein said second ends are opposed in direction to one another.

9. A locking tensioner for a roller blind, the roller blind of the type having a roller and a looped chain or cord to impart rotational movement to the roller, the locking tensioner comprising:
first and second members, each of said first and second members having a first end and a second end, said first ends having apertures dimensioned to receive therethrough the chain or cord of the roller blind,
said first and second members rotatably secured to one another and rotatable about an axis between a locked and an unlocked configuration, when in said unlocked configuration said apertures aligned permitting the chain or cord to freely move through both of said apertures, when in said locked configuration said apertures at least partially misaligned restricting the movement of the chain or cord through said apertures, each of said second ends containing an opening for the passage of a fastener, said second ends aligned and overlying one another when said locking tensioner is in said unlocked configuration to permit a fastener to be received through both of said second ends to secure said tensioner to a window frame,
said locking tensioner including a spring biasing said first and second members toward said locked configuration.

10. The locking tensioner as claimed in claim 9 wherein said spring is a torsion spring that includes a helical portion, said helical portion comprising said axis about which said first and second members rotate when moving between said locked and unlocked configurations.

11. The locking tensioner as claimed in claim 10 wherein said first ends have smooth inner faces, said inner faces in scissor-like contact with each other and slidable past one another when said locking tensioner moves between said unlocked and said locked configurations, when in said locked configuration said torsion spring biasing said first ends in opposite rotational directions, thereby applying a shear load upon a chain or cord passing through said apertures to restrict movement of the chain or cord through said apertures.
